(19) United States
(12) Patent Application Publication
(10) Pub. No.: US 2023/0186209 A1
(43) Pub. Date: Jun. 15, 2023

(54) SYSTEMS AND METHODS TO DEFINE, REBALANCE, AND REPURPOSE A FLEET OF VEHICLES

(71) Applicant: Ford Global Technologies, LLC, Dearborn, MI (US)

(72) Inventors: Richard Twumasi-Boakye, Taylor, MI (US); Shadi Djavadian, Dearborn, MI (US); Xiaolin Cai, Ann Arbor, MI (US); Andrea Broaddus, Berkeley, CA (US); Anthony Leo, Dearborn, MI (US)

(73) Assignee: Ford Global Technologies, LLC, Dearborn, MI (US)

(21) Appl. No.: 17/547,401

(22) Filed: Dec. 10, 2021

(51) Int. Cl. G06Q 10/06

(52) U.S. Cl. CPC G06Q 10/06315

(57) ABSTRACT

Example embodiments described in this disclosure are generally directed to systems and methods for defining and operating a fleet of vehicles. In a first example method, a processor may evaluate a personal attribute of an individual such as, for example, an age of the individual (65+, under 65, infant, etc.) and/or a physical disability (requiring a wheelchair, for example). The processor selects a shared mobility service model that is defined, at least in part, on the basis of the personal attribute of the individual, and then applies the shared mobility service model to identify a first vehicle (having a wheelchair ramp, an infant seat, etc.). The identified vehicle is then assigned to provide service to the individual. In a second example method, a processor may evaluate a demography of a service area (various age groups, various physical disabilities, etc.) and generate a shared mobility service model based on the demography.

### BACKGROUND

Organizations that deal with a fleet of vehicles, for example, a ride-hail operator (Uber®, Lyft®, etc.), typically select the categories of vehicles that can be a part of the fleet based on customer needs. Thus, a ride-hail service operator may select to operate a number of sedans of a first size category (compact), a number of sedans of a second size category (standard), and a number of sedans of a third size category (large, luxury) based on market studies that are directed at identifying various group sizes of passengers who may desire to travel together on rideshare trips. Using this strategy has certain limitations because it fails to address the needs of some type of customers. It is therefore desirable to provide a solution that addresses this deficiency.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system in accordance with the disclosure.

FIG. 2 illustrates a flowchart of an example method to generate a shared mobility service model in accordance with the disclosure.

FIG. 3 illustrates a flowchart of an example method to rebalance a fleet of vehicles in accordance with the disclosure.

FIG. 4 illustrates a flowchart of an example method to repurpose a fleet of vehicles in accordance with the disclosure.

FIG. 5 illustrates a flowchart of an example method to relocate one or more vehicles of a fleet of vehicles in accordance with the disclosure.

FIG. 6 illustrates a flowchart of an example method to generate a demand prediction model in accordance with the disclosure.

FIG. 7 shows some example components that may be included in a vehicle computer and another computer that is communicatively coupled to the vehicle computer, in accordance with disclosure.

### DETAILED DESCRIPTION

### Overview

In terms of a general overview, this disclosure is generally directed to systems and methods for defining, rebalancing, and repurposing a fleet of vehicles. In a first example method in accordance with the disclosure, a processor may evaluate a personal attribute of an individual. The personal attribute can be a physical attribute such as, for example, an age of the individual (65+, under 65, infant, etc.) or a physical disability (requiring a wheelchair, for example). The processor selects a shared mobility service model that is defined, at least in part, on the basis of the personal attribute of the individual, and then applies the shared mobility service model to identify a first vehicle (for example, one that includes a wheelchair ramp and/or a child safety seat). The identified vehicle is then assigned to provide service to the individual. In a second example method, a processor may evaluate a demography of a service area (various age groups, various physical disabilities, etc.) and generate a shared mobility service model based on the demography.

Defining a fleet of vehicles in accordance with the disclosure may involve generating and/or operating upon one or more shared mobility service models. A shared mobility service model can be applied for contextualized use and/or categorization of a fleet of vehicles. In an example scenario, a shared mobility service model can be used to define a fleet of vehicles that include one or more vehicles equipped with items such as, for example, a wheelchair ramp, a child safety seat, and/or package racks. The shared mobility service model may also incorporate time-related features such as, for example, an extended passenger boarding time (to allow a handicapped customer to board/exit the vehicle, for example) and/or an extended passenger wait time (to allow a handicapped customer to perform a shopping chore, for example).

The defining, categorization, and contextualized use of a fleet of vehicles in this manner distinguishes over existing approaches where, for example, a fleet of vehicles is configured to address a broad-spectrum clientele and fails to provide a customized solution that addresses certain specific customer requirements. Furthermore, a fleet of vehicles defined in accordance with disclosure, can be repurposed for a variety of needs in a targeted and flexible manner. Thus, for example, a passenger vehicle that includes a wheelchair ramp for use by a physically handicapped customer over a first period of time, can be repurposed for use over a second period of time, as a cargo vehicle where the wheelchair ramp may be used for loading packages into the cargo vehicle. As another example, a child safety seat in a passenger vehicle may be removed so as to permit an adult to ride in the passenger vehicle in place of a child.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used in this disclosure can pertain to any one of various types of vehicles such as cars, vans, sports utility vehicles, trucks, electric vehicles, gasoline vehicles, hybrid vehicles, and autonomous vehicles. Words such as “goods,” “packages,” and “items” may be used interchangeably and must be understood to be equivalent to each other. Words such as “individuals,” “people,” and “customers,” may be used interchangeably and must be understood to be equivalent to each other. It must also be understood that words such as “implementation,” “scenario,” “case,” “instance,” and “situation” as used herein are an abbreviated version of the phrase “In an example (“implementation,” “scenario,” “case,” “approach,” “instance,” and “situation”) in accordance with the disclosure.” Furthermore, the word “example” as used herein is intended to be non-exclusionary and non-limiting in nature.

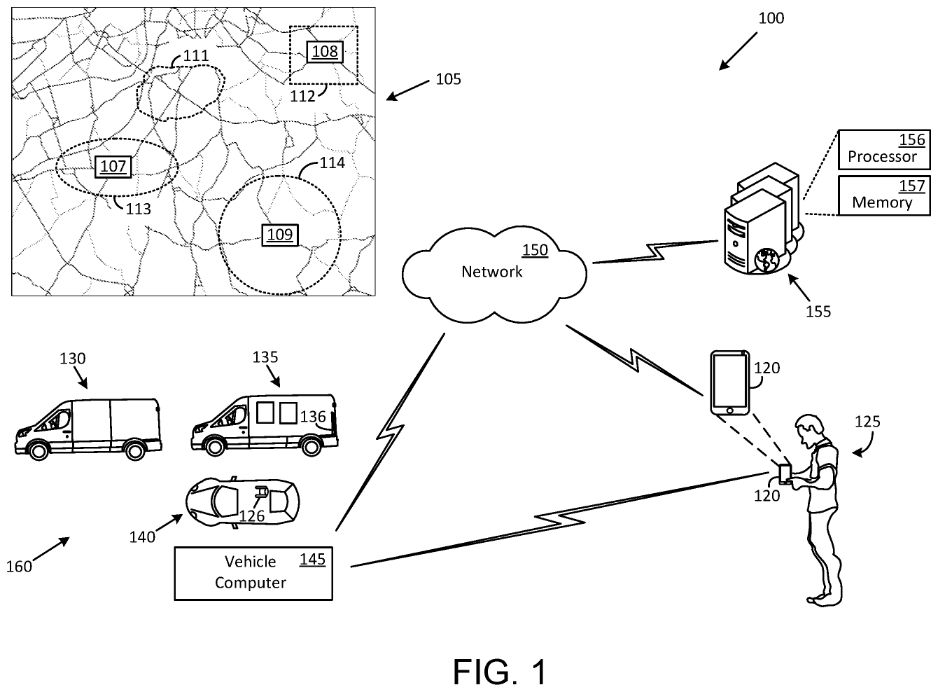

FIG. 1 illustrates an example system 100 in accordance with the disclosure. The system 100 includes a computer 155 that can be an independent/standalone computer in a first example implementation, a client computer in a second example implementation, and a server computer in a third example implementation. In the illustrated example system 100, the computer 155 is coupled to a network 150. The computer 155 may be configured and operated for performing operations such as defining, rebalancing, and/or repurposing a fleet 160 of vehicles.

The fleet 160 can be operated to provide various kinds of services such as, for example, a ride-hail service (Uber®, Lyft® etc.) or a goods transport service (U-Haul®, for example). Some or all of the vehicles may be outfitted with fixtures that are selected in accordance with a shared mobility service model. In an example implementation, the shared mobility service model may be generated on the basis of a demography of a service area 105. The demography of the service area 105 can be defined by factors such as, for example, individuals belonging to a certain age group (65+, for example), individuals belonging to a group having a physical disability, individuals belonging to a group having special needs, individuals who have children (teens, infants, etc.), and/or individuals who use a vehicle for certain activities (work commute, shopping, etc.).

The demography of the service area 105 may also be used to identify various types of vehicles that may be included in the fleet 160. Thus, for example, the fleet 160 can include, a cargo vehicle 130, a van 135 that includes a wheelchair ramp 136, and a sedan 140 that includes a child safety seat 126. The fleet 160 can further include vehicles that do not have fixtures (such as the wheelchair ramp 136, and the child safety seat 126) and may conform to various sizes, types, and shapes (a large luxury vehicle, a sports utility vehicle (SUV), a truck, a bus, a semi-tractor trailer (18-wheeler), a motorcycle, etc.).

Each of the vehicles in the fleet 160 can include a vehicle computer 145 that is configured to wirelessly communicate with various devices either directly (device-to-device) and/or via the network 150. In the illustrated example, the vehicle computer 145 is configured to wirelessly communicate directly with a personal communication device 120 caned by a customer 125 and with the computer 155 via the network 150. The customer 125 represents one of many customers who may be served by the fleet 160. In some embodiments, the vehicle computer 145 may be configured to execute at least some of various operations described below with reference to the computer 155. The vehicle computer 145 may execute such operations either independently and/or in cooperation with the computer 155.

The network 150 may include any one, or a combination of networks, such as a local area network (LAN), a wide area network (WAN), a telephone network, a cellular network, a cable network, a wireless network, and/or private/public networks such as the Internet. For example, the network 150 may support communication technologies such as TCP/IP, cellular, Bluetooth®, Zigbee®, UWB, or near-field-communications (NFC), Wi-Fi, Wi-Fi direct, machine-to-machine communication, man-to-machine communication, and/or a vehicle-to-everything (V2X) communication,

In an example implementation, the vehicle computer 145 may cooperate with the computer 155 to perform various operations in accordance with the disclosure. More particularly, a processor 156 in the computer 155 may execute a code module stored in a memory 157 in the form of computer-executable instructions. The code module can be executed for various purposes such as, for example, to generate a shared mobility service model based on the demography of the service area 105. One or more of such shared mobility service models may be utilized to configure the fleet 160 for providing various services in accordance with the disclosure. Configuring the fleet 160 can include various operations such as, for example, defining the fleet 160 (type of vehicles, number of vehicles, fixtures, etc.), operating the fleet 160 (scheduling, financials, etc.), balancing the fleet 160 (how many of one type of vehicle versus another type of vehicle), rebalancing the fleet 160 (based on a change in the shared mobility service model, for example), and repurposing the fleet 160 (replacing a purpose of operation of a vehicle with a different purpose, for example).

The service area 105 can be any area of interest to a service provider operating the fleet 160, such as, for example, a town, a metropolitan area of a city, or a suburban portion of a city. In an example implementation, the service provider may opt to provide transport services to the entire service area 105 but disallow travel out of the service area 105 (such as, for example, disallow travel from one city to another city). This scenario may be implemented by designating a geofence around the service area 105 and monitoring the movement of all vehicles of the fleet 160 to ensure that none of the vehicles travel outside the service area 105.

In another example implementation, the service provider may opt to provide transport services that are restricted to certain areas inside the service area 105 (such as, for example, in a downtown area of a city, in an area surrounding an airport 108, in an area surrounding a hospital 107, and in an area surrounding a day care center 109). This scenario may be implemented by designating a geofence 111 around the downtown area of the city, a geofence 112 around the area in which the airport 108 is located, a geofence 113 around the area in which the hospital 107 is located, and a geofence 114 around the area in which the day care center 109 is located.

The geofences referred to above may be defined by the computer 155 on the basis of one or more shared mobility service models. A first shared mobility service model may, for example, be based on factors such as types of businesses located in the downtown area of the city, traffic density in the downtown area, traffic density in areas around the downtown area, and/or commute distances between a suburban area of the city and the downtown area of the city. A second shared mobility service model may, for example, be based on factors such as age demographics in an area surrounding the day care center 109, a commute distance between various residences and the day care center 109, and/or physical disabilities of people living in the area surrounding the day care center 109.

In an example implementation, a geofence may be defined by the computer 155 in the form of a set of GPS coordinates, and made available to the vehicle computer 145. The vehicle computer 145 may then cooperate with the computer 155 to implement various operations such as, for example, detecting and reporting to the computer 155, a violation of the geofence by a vehicle.

The personal communication device 120 of the customer 125, which can be any of various devices such as, for example, a smartphone, a tablet computer, or a phablet (phone plus tablet or an iPod Touch®), can be used by the customer 125 to communicate with the computer 155 to make a request for a vehicle. In accordance with the disclosure, a request procedure may allow the customer 125 to provide information such as, for example, a request for a child safety seat, a request for a wheelchair ramp, a description of a personal attribute of the customer 125, and time-factors associated with a trip (an extended wait time for undertaking a shopping trip to a mall, for example).

In an example method in accordance with the disclosure, the processor 156 may evaluate the personal attribute of the customer 125 (age of the individual (65+, under 65, infant, etc.) and/or a physical disability (requiring wheelchair facilities, for example). The processor 156 selects a shared mobility service model that is defined, at least in part, on the basis of the personal attribute of the customer 125, and then applies the shared mobility service model to identify a vehicle (having a wheelchair ramp, an infant seat, etc.). The identified vehicle is then assigned to provide service to the customer 125.

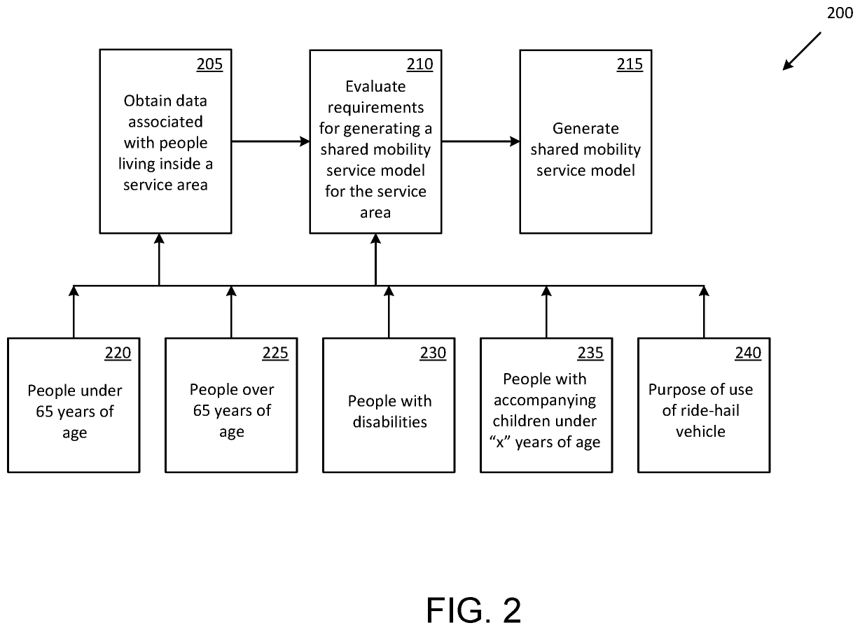

FIG. 2 illustrates a flowchart 200 of an example method to generate a shared mobility service model in accordance with the disclosure. The flowchart 200 (and other flowcharts described below) illustrates a sequence of operations that can be implemented in hardware, software, or a combination thereof. In the context of software, the operations represent computer-executable instructions stored on one or more non-transitory computer-readable media such as the memory 157, that, when executed by one or more processors such as the processor 156, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 200 may be carried out by using a software application that may be downloaded into the computer 155. Some of the aspects of the flowchart 200 are described below using the system 100 shown in FIG. 1. However, it should be understood that the description is equally pertinent to various other embodiments in accordance with the disclosure.

At block 205, the processor 156 of the computer 155 obtains data associated with people living inside the service area 105, including, for example, demographic data (age, family details, etc.), address information, distance information, traffic information, timing information, etc.

Block 220 corresponds to a first example classification defined on the basis of age. In this example, the first example classification corresponds to people under 65 years of age. Block 225 corresponds to a second example classification that is also defined on the basis of age. In this example, the second example classification corresponds to people over 65 years of age. Block 230 corresponds to a third example classification that is defined on the basis of a physical disability. The third example classification can correspond, for example, to people who require certain types of accessories to be provided in a vehicle such as, for example, a wheelchair ramp, a low height step, a larger cabin area that accommodates a wheelchair, and items catering to special needs such as, for example, Braille labels, machine voice assistance, etc.

Block 235 corresponds to a fourth example classification that is defined on the basis of children. The fourth example classification can correspond, for example, to people who travel with children. The children may be further classified on the basis of age such as, for example, children under “x” years of age who can travel in a vehicle only when seated in a child safety seat.

Block 240 corresponds to a fifth example classification that is defined on the basis of a purpose of use of a vehicle. The fifth example classification may be applicable to various scenarios where people may need different types of vehicles based on different types of use. A first example scenario can involve a shopping trip by one or more people over the age of 65 years (grandparents, for example) accompanied by one or more children. The first example scenario may necessitate the use of a first type of vehicle based on size and fixtures (special seating configuration, child proof doors and windows, etc,). A second example combination scenario can involve an emergency visit to a medical center by an adult accompanied by an injured child. The second combination scenario may necessitate the use of a second type of vehicle based on, for example, precluding bucket seats and including an elongated back seat. A third example combination scenario can involve travel by a group of people over the age of 65 years chauffeured by a young driver. The third combination scenario may necessitate the use of a third type of vehicle (a van or minibus, for example). A fourth combination scenario can involve a family (adults and children) traveling on a family vacation carrying a number of items (luggage, food, recreational material, etc.). The fourth combination scenario may necessitate the use of a fourth type of vehicle (family sedan with ample trunk space).

At block 210, the processor 156 uses the obtained data and evaluates requirements for generating a shared mobility service model for the service area 105. In an example scenario, the shared mobility service model may include defining one or more geofences inside the service area 105 such as, for example, the various geofences described above (geofence 111, geofence 112, geofence 113, and geofence 114.

At block 215, the processor 156 generates a shared mobility service model based on the evaluation. The shared mobility service model may be stored in a database of the computer 155. In an example implementation, the shared mobility service model that is stored in the database is made available for use by various entities such as, for example, a ride-hail service operator.

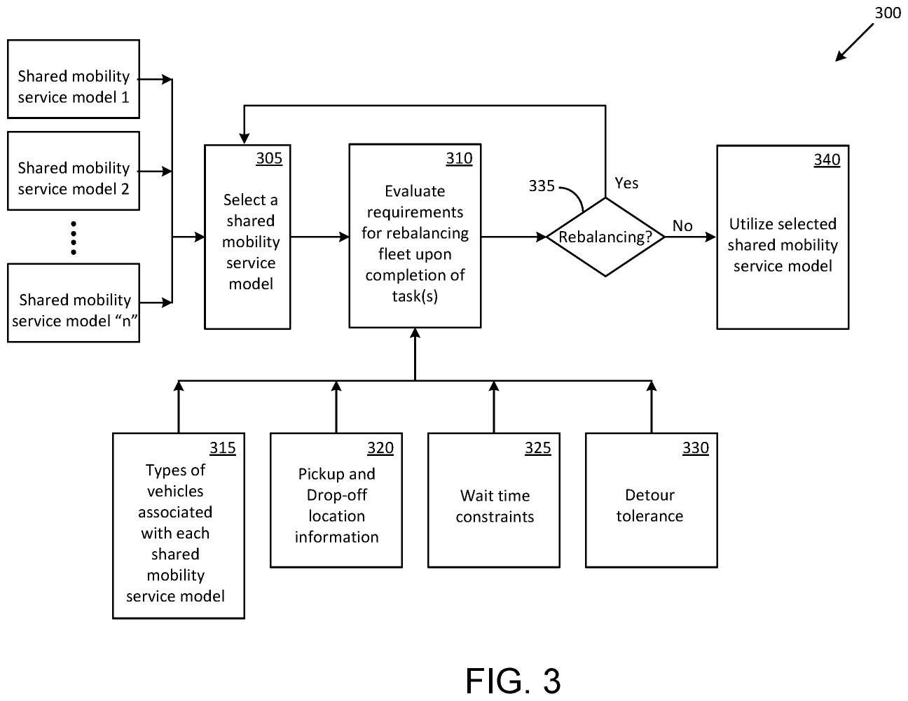

FIG. 3 illustrates a flowchart 300 of an example method to rebalance the fleet 160 in accordance with the disclosure. At block 305, the processor 156 of the computer 155 selects a shared mobility service model such as, for example, one of “n” shared mobility service models (n≥2).

At block 310, the processor 156 evaluates requirements for rebalancing the fleet 160. The evaluation may be carried out at various instants in time such as, for example, on a periodic basis, upon completion of a service (for example, upon completion of a passenger ride-hail operation), or in order to modify the financials of an operation (to increase profits, for example). In one scenario, the evaluation may be carried out upon each individual vehicle of the fleet 160 such as, for example, upon completion of a trip (or a number of trips). In another scenario, the evaluation may be carried out upon more than one vehicle or upon all vehicles of the fleet 160 (for example, on an annual basis).

In an example implementation, the evaluation may be carried out using various kinds of information related to operating the fleet 160. A first example information that is indicated in block 315 pertains to one or more types of vehicles that may be associated with the various shared mobility service models. For example, the shared mobility service model 1 may involve deployment of passenger type vehicles that are configured to transport customers of specific age groups (over 65, under 65, young children, etc.). The shared mobility service model 2 may involve deployment of passenger type vehicles that are configured to transport customers with physical disabilities. Another shared mobility service model may involve deployment of vehicles that are configured to transport goods (a U-Haul vehicle, for example).

A second example information that is indicated in block 320 pertains to pick up and/drop-off locations for various customers. In an example scenario, the processor 156 may use this information to redefine the service area 105 and/or one more geofences (if present).

A third example information that is indicated in block 325 pertains to wait time constraints. In an example scenario, the fleet 160 may currently cater to a first set of customers. The first set of customers are office goers who use the vehicles in a ride-share arrangement to commute to work. No wait times are involved at the work place. A rebalancing of the fleet 160 may be carried out if it is desirable to cater to a different set of customers who desire to go shopping, for example, and would prefer vehicles to wait during the shopping trip.

A fourth example information that is indicated in block 330 pertains to detour tolerance. In an example scenario, the fleet 160 may currently cater to a set of customers who are office goers pressed for time and have low detour tolerance. A rebalancing of the fleet 160 may be carried out if it is desirable to cater to another set of customers who are not time-constrained (tourists, for example) and have a higher level of detour tolerance.

At block 335, the processor 156 determines whether a rebalancing of the fleet 160 is required. In some cases, additional input may be provided to the processor 156 by an individual, such as, for example, a ride-hail services operator.

If no rebalancing is desired, at block 340, the shared mobility service model that is selected (per block 305) is utilized. If rebalancing is desired, operations indicated by block 305 and subsequent blocks are executed. For example, a rebalancing may be desired based on a change in a demography of the service area 105 and/or based upon a trade-off between costs and profits. In some cases, rebalancing may involve reverting to shared mobility service model 1 that was used prior to use of shared mobility service model 2.

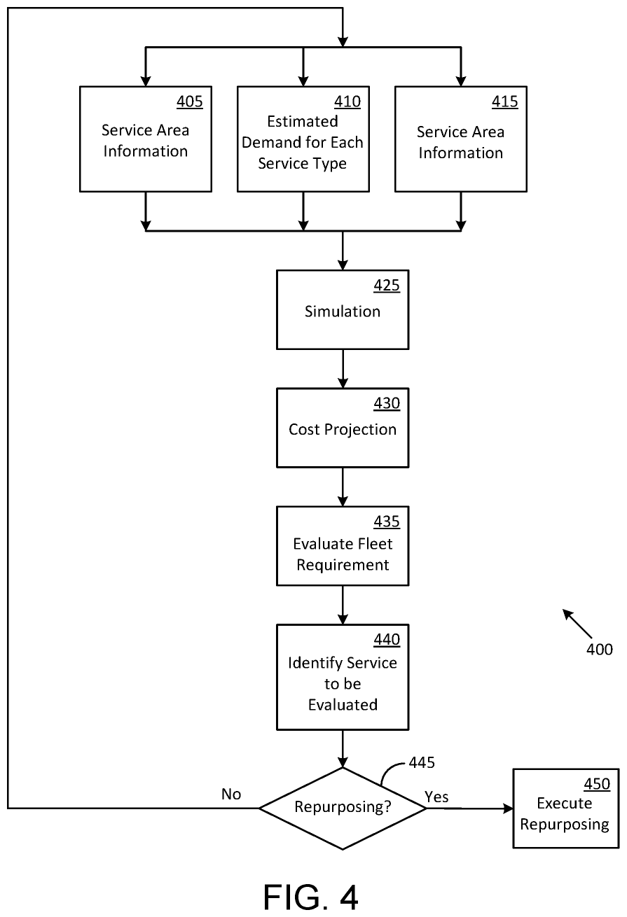

FIG. 4 illustrates a flowchart 400 of an example method to repurpose the fleet 160 in accordance with the disclosure. At block 405, the processor 156 of the computer 155 obtains information about the service area 105. The information can include, for example, any geofences present inside the service area 105, road network information and location information of various structures, such as, for example, a business, an institution, a residence, a school, or a hospital.

At block 410, the processor 156 executes an operation to estimate demand for each of various service types (passenger transport, goods transport, special needs, etc.).

At block 415, the processor 156 executes an operation to determine a distribution of vehicles of the fleet 160 in the service area 105. In an example implementation, the operation may be performed in real time.

At block 425, the processor 156 executes a pre-run simulation operation to determine, for example, per vehicle revenue for each of various vehicle types at various demand levels. The pre-run simulation operation may take into consideration factors such as, for example, boarding times and alighting times for elderly customers or customers having children. The pre-run simulation operation, which may be performed ahead of time before one or more vehicles are available for repurposing, may be followed by a simulation operation when the vehicle(s) is available for repurposing.

At block 430, the processor 156 executes a cost projection procedure to evaluate, for example, projected cost benefits or losses associated with services provided by one or more vehicles of the fleet 160.

At block 435, the processor 156 evaluates various requirements of the fleet 160 for a desired repurposing, particularly with respect to an existing configuration of the fleet 160. The requirements can involve, for example, addition of one or more vehicles of one or more types to the fleet 160 and/or getting rid of one or more vehicles currently included in the fleet 160.

At block 440, the processor 156 evaluates one or more services offered by vehicles of the fleet 160 for identifying cost benefits based on repurposing one or more vehicles of the fleet 160.

At block 445, a determination is made whether repurposing of one or more vehicles is desirable. If yes, at block 450, the one or more vehicles are repurposed. If not, the various operations described above may be repeated at a later instant in time and may be directed, for example, at balancing short-term demands versus long-term demands for the services of the fleet 160.

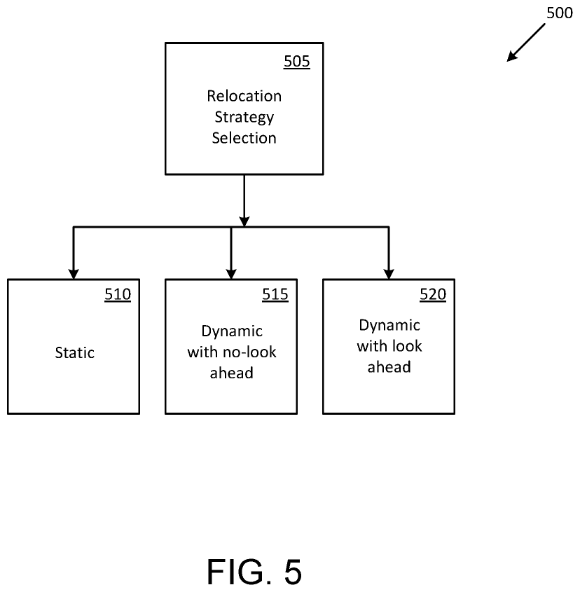

FIG. 5 illustrates a flowchart 500 of an example method to relocate one or more vehicles of the fleet 160 in accordance with the disclosure. At block 505, the processor 156 may select one of various relocation strategies. A first example relocation strategy that is indicated in block 510 is a static strategy. A second example relocation strategy that is indicated in block 515 involves a dynamic strategy with no-look-ahead. A third example relocation strategy that is indicated in block 520 involves a dynamic strategy with look-ahead.

The three example relocation strategies differ from each other in terms of reliance on updated information. Static strategy does not consider current and future states of an operating environment (i.e., relocation decision xᵢ is independent of state Rₜ). Some examples of the use of a static strategy involves operations such as a vehicle returning to a base station at the end of a trip and a vehicle staying at a current location after completing a trip.

Dynamic strategies use updated information to predict a future state of an operating environment and make decisions accordingly. The dynamic strategy with no look-ahead can include a relocation decision that may be expressed as follows:

xₜ=f(Rₛ),s≥t

Some examples of the use of a dynamic strategy with no look-ahead involve myopic operations and rolling horizon states where estimated future states may be expressed as follows:

[symbol]

=f(Rₜ),s>t

The dynamic strategy with look-ahead, which considers the dependency of future states on future and current decisions, may be advantageously used for various relocation operations in accordance with the disclosure. A relocation decision based on a dynamic strategy with look-ahead may be expressed as follows:

f [symbol] (xₜ,Rₜ),xₛ(xₜ,Rₜ)),S>t.

Some examples of the use of a dynamic strategy with look-ahead can involve a one-stage look ahead approach, a scenario tree, and/or an infinite horizon steady state approximation.

Markov Decision Processes (MDP) are often employed by researchers to find optimal non-myopic (with look-ahead) dynamic policies. Since discrete time intervals are assumed, the Bellman equation by Powell (2011) may be used to find an optimal solution:

$${V}_{t} ( {R}_{t} ) = {max}_{{x}_{t}} ( {P}_{t} ( {x}_{t} , {R}_{t} ) + γ E [ {V}_{t + 1} ( {R}_{t + 1} ) \vert ( {x}_{t} , {R}_{t} ) ] )$$

In the context of a dynamic policy, Pₜ(xₜ, Rₜ) represents an immediate relocation profit, whereas, E[Vₜ₊₁(Rₜ₊₁)|(xₜ, Rₜ)] is an expected future profit conditional on the new locations of idle vehicles. The expression Vₜ₊₁(Rₜ₊₁) is the value of an optimal dynamic policy and y is a discount factor. At every time interval T, a centralized operator policy queries a set that includes all idle vehicles and current demand levels. Furthermore, the centralized operator can predict demand for every time interval T+1 using trained demand prediction machine learning model. Utilizing data pertaining to a current demand, future demand, and available vehicles, the centralized operator returns a set of relocation recommendations to all idle vehicles.

The processor 156 may evaluate several shared mobility service models to explore a profit associated with relocating and assigning each idle vehicle. Deep reinforcement learning can be employed to perform such evaluations.

For each shared mobility service models T, at a given demand level, the relationship between served demand and fleet size may follow the function:

yᵢ=aᵢxᵢ²+bᵢxᵢ+Zᵢ

where yⱼ is the served demand for service model T; xᵢ is the fleet size for shared mobility service model T; and aᵢ, bᵢ, and zᵢ are constants.

The net profit for switching vehicle from service ‘i’ to an eligible shared mobility service model ‘j’, Pᵢⱼ may be expressed as follows:

Pᵢⱼ=pⱼ−(cᵢ+csᵢⱼ)

Each shared mobility service model I may be expressed as follows:

pᵢ=cᵢ=(2aᵢxᵢ+bᵢ)*fᵢ

where fᵢ is a fare per trip for a shared mobility service model; pⱼ is a profit generated for one additional vehicle in service; cᵢ is the cost for losing one vehicle in service; and csiⱼ is the cost for repurposing the vehicle from i to j (replacing one accessory with another, for example).

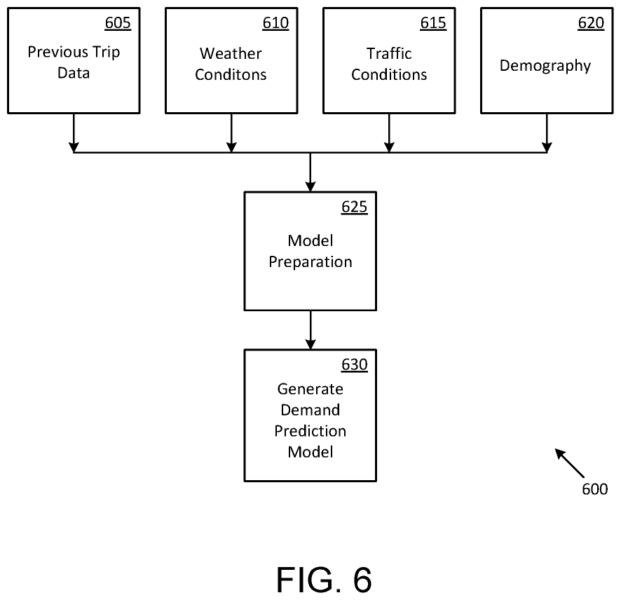

FIG. 6 illustrates a flowchart 600 of an example method to generate a demand prediction model in accordance with the disclosure. At block 605, the processor 156 obtains trip-related data from previous trips made by a vehicle. The trip-related data can include, for example, a day on which the trip was made, an originating location, a destination location, a pick-up location, and a drop-off time. At block 610, the processor 156 obtains data related to weather conditions in the service area 105. At block 615, the processor 156 obtains data related to traffic conditions. At block 620, the processor 156 obtains data associated with a demography of the service area 105.

At block 625, the processor 156 executes a model preparation procedure that can include identifying explanatory and/or response variables by using information available from various sources (experts, databases, etc.)

At block 630, the processor 156 generates a demand prediction model by using various techniques such as, for example, machine learning techniques, decision trees, random forest techniques etc. In an example implementation, the shared mobility service model may be generated offline and applied online whenever rebalancing is desired.

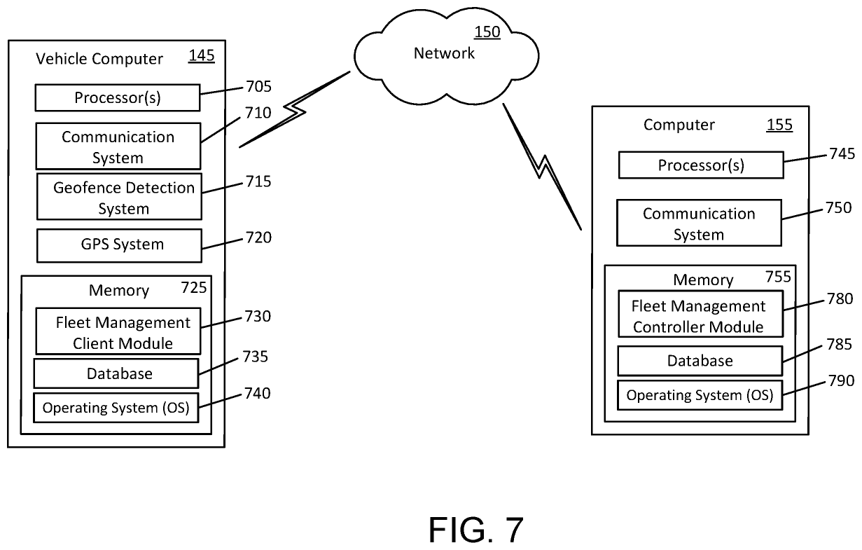

FIG. 7 shows some example components that may be included in the vehicle computer 145 and in the computer 155 in accordance with disclosure. In this example configuration, the vehicle computer 145 may include a processor 705, a communication system 710, a GPS system 720, and a memory 725. The communication system 710 can include a transceiver that allows the vehicle computer 145 to communicate with various components such as the computer 155 and the personal communication device 120.

Communications between the vehicle computer 145 and various components in a vehicle in which the vehicle computer 145 may be located can be carried out over a bus (not shown). The bus can be implemented using one or more of various wired and/or wireless technologies. For example, the bus can be a vehicle bus that uses a controller area network (CAN) bus protocol, a Media Oriented Systems Transport (MOST) bus protocol, and/or a CAN flexible data (CAN-FD) bus protocol. Some or all portions of the bus may also be implemented using wireless technologies such as Bluetooth®, Zigbee®, UWB, or near-field-communications (NFC), cellular, Wi-Fi, Wi-Fi direct, machine-to-machine communication, and/or man-to-machine communication.

The processor 705 may operate the geofence detection system 715 and the GPS system 720 for detecting various features related to a geofence. For example, the geofence detection system 715 may cooperate with the GPS system 720 for detecting one or more of the geofence 111, geofence 112, geofence 113, and geofence 114 shown in FIG. 1. In some example implementations, the geofence detection system 715 can use other techniques to identify one or more boundaries of a geofence, such as, for example, dead reckoning techniques, image processing techniques (by identifying landmarks), or manual input from a driver of the vehicle.

The memory 725, which is one example of a non-transitory computer-readable medium, may be used to store an operating system (OS) 740 and one or more code modules such as a fleet management client module 730. The code modules can be provided in the form of computer-executable instructions that are executed by the processor 705 for performing various operations in accordance with the disclosure. The memory 725 may also include a database 735 that can be used to store information such as, for example, geofence information and restrictions associated with a geofence.

The processor 705 can execute the fleet management client module 730 to perform various actions, such as, for example, responding to a request from the customer 125 and responding to commands issued by the computer 155. The computer 155 may issue the commands for executing operations such as, for example, rebalancing and/or repurposing the fleet 160.

The computer 155 may include a processor 745, a communication system 750, and a memory 755. The communication system 750 can include a transceiver that allows the computer 155 to communicate with the vehicle computer 145 via the network 150. The memory 755, which is another example of a non-transitory computer-readable medium, may be used to store an operating system (OS) 790 and one or more code modules such as a fleet management controller module 780. The code modules can be provided in the form of computer-executable instructions that are executed by the processor 745 for performing various operations in accordance with the disclosure. The memory 755 may also include a database 785 that can be used to store information such as, for example, one or more shared mobility service models, service area information, and geofence-related information.

The processor 745 can execute the fleet management controller module 780 to perform various actions, such as, for example, to generate a shared mobility service model, to define a fleet of vehicles based on the shared mobility service model, to rebalance the fleet based on the shared mobility service model, to repurpose the fleet based on the shared mobility service model, to define a geofence, and to enforce actions associated with the geofence.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 205, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 725 or the memory 755, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
evaluating, by a processor, a personal attribute of a first individual;
selecting, by the processor and based of the personal attribute of the first individual, a shared mobility service model;
identifying, by the processor and based on applying the shared mobility service model, a first vehicle; and
assigning, by the processor, the first vehicle to provide a transportation service to the first individual.

2. The method of claim 1, wherein the first vehicle is a part of a fleet of vehicles, wherein the personal attribute is a physical attribute, wherein the shared mobility service model is defined by a first purpose of use of the first vehicle, and wherein identifying the first vehicle comprises identifying a capability of the first vehicle to be repurposed from the first purpose of use to a second purpose of use.

3. The method of claim 2, wherein the physical attribute is at least one of an age or a physical disability, and wherein the first purpose of use comprises at least one of transporting the first individual from a first location to a second location or transporting an item from a third location to a fourth location.

4. The method of claim 3, wherein assigning the first vehicle to provide the transportation service to the first individual is subject to the first vehicle having a configuration that addresses the at least one of the age or the physical disability of the first individual.

5. The method of claim 3, wherein the first individual is a child and wherein the first vehicle has a configuration that includes a child safety seat to accommodate the child.

6. The method of claim 1, wherein the shared mobility service model is further defined by a first purpose of use of the first vehicle and wherein the method further comprises:
determining, by the processor, a completion of the first purpose of use of the first vehicle by the first individual;
evaluating, by the processor, a second purpose of use by a second individual; and
assigning, by the processor, the first vehicle to the second individual for the second purpose of use.

7. The method of claim 6, wherein the personal attribute of the first individual is an age of the first individual, the age of the first individual belonging to a first age group, and further wherein an age of the second individual belongs to a second age group that is different than the first age group.

8. A method comprising:
evaluating, by a first processor, a demography of a service area;
generating, by the first processor, a shared mobility service model that is defined, at least in part, by the demography of the service area;
identifying, by the first processor, based on applying the shared mobility service model, a first type of vehicle; and
assigning, by the first processor, a first vehicle to provide transportation services inside the service area.

9. The method of claim 8, wherein the first type of vehicle is configured for one of transporting individuals or transporting goods.

10. The method of claim 8, wherein the demography of the service area is defined by a number of individuals belonging to a first age group, and wherein identifying the first type of vehicle comprises evaluating a configuration of the first type of vehicle to provide transportation services to individuals belonging to the first age group.

11. The method of claim 8, wherein the demography of the service area is defined by a number of individuals belonging to a group having a first physical disability, and wherein identifying the first type of vehicle comprises evaluating a configuration of the first type of vehicle to provide transportation services to individuals having the first physical disability.

12. The method of claim 8, further comprising:
defining, by the first processor, a geofence around the service area;
monitoring, by a second processor, a movement of the first vehicle after assigning the first vehicle to provide transportation services inside the service area;
detecting, by the second processor, a violation of the geofence; and
executing, by the second processor, a responsive action upon detecting the violation.

13. The method of claim 8, wherein the shared mobility service model is further defined by a first purpose of use of the first vehicle and wherein the method further comprises:
determining, by the first processor, a completion of the first purpose of use of the first vehicle by a first individual;
evaluating, by the first processor, a second purpose of use by a second individual; and
assigning, by the first processor, the first vehicle to the second individual for the second purpose of use.

14. The method of claim 13, wherein the first purpose of use is transporting the first individual from a first location to a second location inside the service area and wherein the second purpose of use is transporting an item from a third location to a fourth location inside the service area.

15. An apparatus comprising:
a memory that stores computer-executable instructions; and
a processor configured to access the memory and execute the computer-executable instructions to perform operations comprising:
evaluating a personal attribute of a first individual;
selecting a shared mobility service model that is defined, at least in part, on the personal attribute of the first individual;
identifying a first vehicle, based on applying the shared mobility service model; and
assigning the first vehicle to provide a transportation service to the first individual.

16. The apparatus of claim 15, wherein the first vehicle is a part of a fleet of vehicles, wherein the personal attribute is a physical attribute, and wherein the shared mobility service model is further defined by a first purpose of use of the first vehicle.

17. The apparatus of claim 16, wherein the physical attribute is at least one of an age or a physical disability, and wherein the first purpose of use comprises at least one of transporting the first individual from a first location to a second location or transporting an item from a third location to a fourth location.

18. The apparatus of claim 17, wherein assigning the first vehicle to provide the transportation service to the first individual is subject to the first vehicle having a configuration that addresses the at least one of the age or the physical disability of the first individual.

19. The apparatus of claim 17, wherein the first individual is a child and wherein the first vehicle has a configuration that includes a child safety seat to accommodate the child.

20. The apparatus of claim 15, wherein the shared mobility service model is further defined by a first purpose of use of the first vehicle and wherein the processor is further configured to access the memory and execute additional computer-executable instructions to perform additional operations comprising:
determining a completion of the first purpose of use of the first vehicle by the first individual;
evaluating a second purpose of use by a second individual; and
assigning the first vehicle to the second individual for the second purpose of use.
